(19) United States
(12) Patent Application Publication
(10) Pub. No.: US 2003/0067482 A1
(43) Pub. Date: Apr. 10, 2003

(54) Virtual environment on the web

(76) Inventor: Yandi Ongkojoyo, Boston, MA (US)

Correspondence Address: YANDI ONGKOJOYO, 517 HANCOCK STREET, APT# 21, QUINCY, MA, 02170, US

(21) Appl. No.: 09/973,352

(22) Filed: Oct. 9, 2001

(51) Int. Cl. G09G 5/00

(52) U.S. Cl. 345/744; 345/751

(57) ABSTRACT

A system for building and displaying virtual reality environment over a network (including the Internet). The virtual reality environment comprises general web sites, e-commerce web sites, and game web sites.

### CROSS-REFERENCE TO RELATED APPLICATIONS

Not applicable.

### BACKGROUND-FIELD OF THE INVENTION

This invention relates generally to web programming and virtual reality, and more particularly to the deployment of a virtual environment on the web.

### BACKGROUND-DESCRIPTION OF PRIOR ART

Surfing on the web is generally accomplished using a browser to view web pages that uses conventional user interfaces. The controls are usually limited to standard user interfaces comprising buttons, checkboxes, combo boxes, and other conventional user interface elements.

Commercial e-commerce sites use said common interfaces to interact with users. Said users use interfaces to purchase goods and services.

### SUMMARY OF THE INVENTION

The primary object of the invention is to provide a system that allows people to surf the net using a virtual reality user interface without having to download proprietary software or plug-ins.

Another object of the invention is to create an e-commerce website that uses virtual reality user interface.

Another object of the invention is to create virtual environments on the Internet.

In accordance with the present invention a system comprises computer programs residing on a computer-readable medium includes instruction for causing the system to:

(a) display virtual reality interface.

(b) react to user's command.

(c) open other web pages.

(d) invoke other functions, applications or web services.

### OBJECTS AND ADVANTAGES

This invention has some advantages over traditional web surfing techniques: more fun to use and easier to visualize.

### BRIEF DESCRIPTION OF THE DRAWINGS

The foregoing features and other aspects of this invention will now be described in accordance with the drawings in which:

FIG. 1 is a diagram of the suggested application and requirement or configuration of the system for general uses.

FIG. 2 is an activity diagram, showing the basic features of the system.

### DETAILED DESCRIPTIONS OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

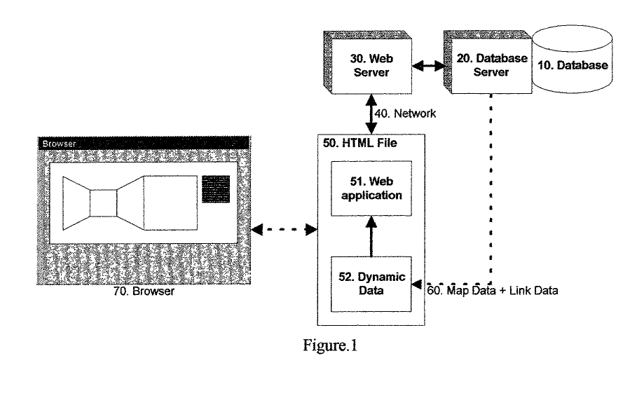

Referring now to FIG. 1, The system comprises a web server (30) and a database server (20) with a database (10). Said web server (30) provides HTML files (50). Map data and link data (60) as dynamic data (52) can be embedded to said HTML files (50) or downloaded from said database server (20) by web application (51). Said web server (30) sends said HTML files (50) via network (40). Said HTML files (50) with web application (51) is displayed using web browser (70).

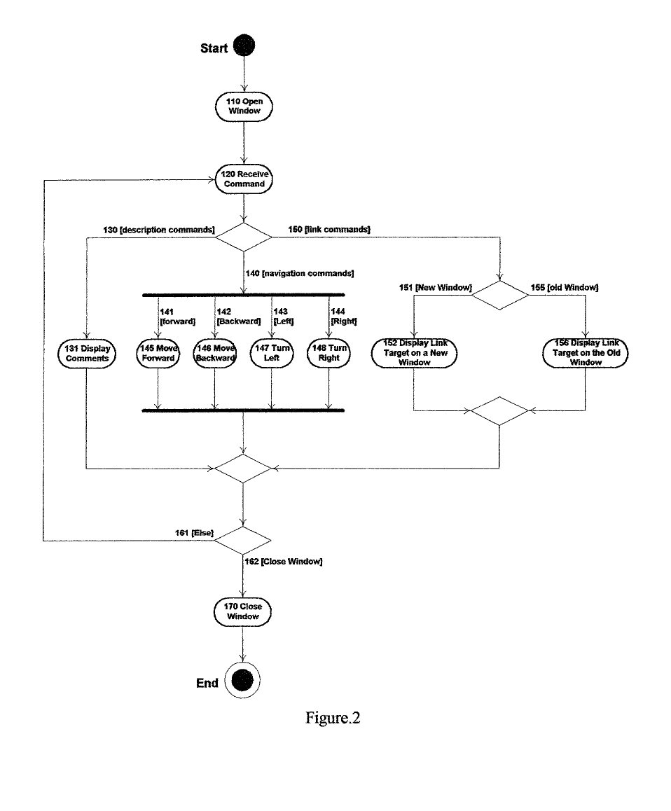

Referring now to FIG. 2, The system starts ring when a user open a browser window (110). Said system then shows a virtual reality user interface and ready to receive commands (120) from said user.

Said commands comprise description commands (130), navigation commands (140), and link commands (150).

The system responses to said description commands (130) by displaying relevant comments (131).

The system responses to said navigation commands (140) comprise forward command (141), backward command (142), left command (143), and right command (144).

Said forward command (141) causes user to move forward (145).

Said backward command (142) causes user to move backward (146).

Said left command (143) causes user to turn left (147).

Said right command (144) causes user to turn right (148).

Said link commands (140) comprise new window command (151) and old window command (155).

Said new window command (151) displays a link as a new window (152).

Said old window command (155) displays a link in the current window (156). If the user assigns a close window command (162), the system will close the browser window and end the process. Otherwise (161), the system is ready for the next command.

What is claimed is:

1. A method for displaying a virtual reality environment on the web comprising the steps of:
(a) downloading virtual reality web application;
(b) downloading virtual environment data;
(c) displaying virtual reality environment using a browser;
whereby a user can use any operating system to display the virtual environment.

2. A system for building web sites or web services with virtual reality environment, comprising:
(a) general web sites;
(b) e-commerce web sites;
(c) online-game web sites;

3. The system of claim 2 wherein further comprising virtual reality hardware interfaces;
(a) first means [input devices] for acquiring input from users;
(b) second means [output devices] for displaying information;

4. A computer program product having a computer readable medium having computer program logic recorded thereon, as a part of the system of claim 1, comprising means for displaying virtual reality environment; means for building virtual reality web sites or virtual environment; and means for delivering the virtual environment via Internet.

5. The computer program of claim 4 wherein said program further comprises means [a conversation-like password verification system] for user verification.

6. The computer program of claim 4 wherein said program further comprises means [an interaction system] for allowing multiple users to interact each other.

7. The computer program of claim 4 wherein said program further comprises means [an interaction system] for allowing a user to assign a virtual entity to represent said user.
